(19) United States
(12) Patent Application Publication
(10) Pub. No.: US 2020/0258052 A1
(43) Pub. Date: Aug. 13, 2020

(54) APPOINTMENT SCHEDULING BASED ON PREDICTED TRAVEL TIME

(71) Applicant: TimeTrade Systems, Inc., Tewksbury, MA (US)

(72) Inventor: Mukul Goyal, Tewksbury, MA (US)

(21) Appl. No.: 16/561,438

(22) Filed: Sep. 5, 2019

Related U.S. Application Data
(60) Provisional application No. 62/803,868, filed on Feb. 11, 2019.

(51) Int. Cl. G06Q 10/10; G01C 21/34

(52) U.S. Cl. CPC G06Q 10/1095; G01C 21/3484

(57) ABSTRACT

In one example, a server obtains a location of a user, a location of a physical appointment, and one or more dynamic appointment parameters. Based on the location of the user, the location of the physical appointment, and the one or more dynamic appointment parameters, the server calculates a predicted travel time between the location of the user and the location of the physical appointment. Based on the predicted travel time, the server determines whether the user can arrive at the location of the physical appointment before a potential start time of the physical appointment. If it is determined that the user can arrive at the location of the physical appointment before the potential start time of the physical appointment, the server provides, to the user, an indication of the potential start time for the physical appointment.

### CROSS REFERENCE TO RELATED APPLICATION

This application claims the benefit of U.S. Provisional Application No. 62/803,868 filed Feb. 11, 2019, the entirety of which is incorporated herein by reference.

### TECHNICAL FIELD

The present disclosure relates to dynamic scheduling of meetings.

### BACKGROUND

People who travel for scheduled meetings need to ensure that they have sufficient time to travel to the meeting. However, users are often late to meetings, or miss the meetings entirely, because they incorrectly estimated the travel time or other unexpected circumstances arose (e.g., due to weather or traffic). This can create inefficiencies for people and enterprises alike.

### BRIEF DESCRIPTION OF THE DRAWINGS

FIG. 1 illustrates a system configured to schedule an appointment based on predicted travel time, according to an example embodiment.

FIG. 2 illustrates an indication of a potential start time of an appointment displayed on a user device, according to an example embodiment.

FIG. 3 illustrates a block diagram of a computing device configured to schedule an appointment based on predicted travel time, according to an example embodiment.

FIG. 4 illustrates a flowchart of a method for scheduling an appointment based on predicted travel time, according to an example embodiment.

### DESCRIPTION OF EXAMPLE EMBODIMENTS

### Overview

Techniques are described herein for appointment scheduling based on predicted travel time. In one example embodiment, a server obtains a location of a user, a location of a physical appointment, and one or more dynamic appointment parameters. Based on the location of the user, the location of the physical appointment, and the one or more dynamic appointment parameters, the server calculates a predicted travel time between the location of the user and the location of the physical appointment. Based on the predicted travel time, the server determines whether the user can arrive at the location of the physical appointment before a potential start time of the physical appointment. If it is determined that the user can arrive at the location of the physical appointment before the potential start time of the physical appointment, the server provides, to the user, an indication of the potential start time for the physical appointment.

### Example Embodiments

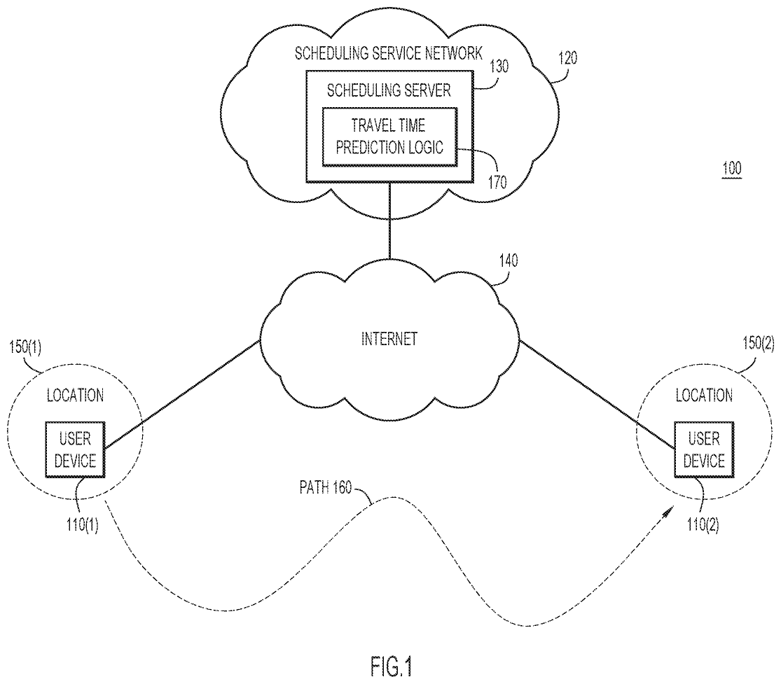

FIG. 1 illustrates an example system 100 configured to schedule an appointment based on predicted travel time. System 100 includes user devices 110(1) and 110(2), scheduling service network 120 including scheduling server 130, and Internet 140. User devices 110(1) and 110(2) and scheduling service network 120 are configured to communicate via Internet 140. User devices 110(1) and 110(2) may be personal or enterprise computers, laptops, smartphones, etc. User device 110(1) may be located in location/geographic area 150(1), and user device 110(2) may be located in location/geographic area 150(2). In one example, a user of user device 110(1) is an employee who wishes to schedule an in-person (and/or on-site) appointment/meeting with a user of user device 110(2), who is a customer of the employee.

Traditionally, to schedule the appointment, one of the employee and the customer would send an appointment reservation/invitation/request for the other to accept (or respond with a different proposed start time). Because the meeting is in-person the sender should account for the time required to travel from location 150(1) to location 150(2). For example, the sender may need to budget for the time required for the employee to travel along path 160 from location 150(1) to location 150(2). Conventional systems can place undue burden on network resources (e.g., processors, memory, etc.) because of network communications associated with cancelling and/or rescheduling incorrectly estimated appointments.

For example, the sender could manually estimate the travel time, but the manually estimated travel time is often incorrect due to unforeseen events (e.g., weather, traffic, etc.), or simply because the sender made a bad guess. If the manually estimated travel time is too great, the employee might lose valuable productivity by arriving long before the start time of the in-person appointment. Conversely, if the estimated travel time is too small, the employee might arrive after the start time of the in-person appointment, and possibly miss the appointment altogether. An automated static/fixed amount of time around the appointment time also fails to properly account for the travel time of the employee because the travel time can vary depending on the particular use case.

Accordingly, scheduling server 130 includes travel time prediction logic 170 which causes scheduling server 130 to perform operations described herein that are consistent with scheduling an appointment based on predicted travel time. Scheduling server 130 may obtain (e.g., via Internet 140) a location of the user of user device 110(1) (here, location 150(1)).

Location 150(1) may be a current location of the user of user device 110(1), for example, when the user of user device 110(1) is booking a same-day appointment. In this case, because of the close proximity of the user of user device 110(1) and user device 110(1), the location of the user of user device 110(1) may effectively be the same as the location of user device 110(1). For instance, the location of the user of user device 110(1) may be obtained through Global Positioning System (GPS) coordinates of user device 110(1).

Location 150(1) may alternatively be an anticipated location of the user of user device 110(1), for example, when the user of user device 110(1) is booking a future appointment. For example, scheduling server 130 may obtain location 150(1) from one or more calendar or other applications storing location 150(1) locally in user devices 110(1) and/or 110(2), or from any other suitable source indicating when the user of user device 110(1) will be at location 150(1).

Scheduling server 130 may also obtain a location of the physical appointment (here, location 150(2)). In one example, scheduling server 130 may obtain location 150(2) through GPS coordinates of user device 110(2). In another example, scheduling server 130 may obtain location 150(2) from one or more calendar or other applications storing location 150(2) locally in user devices 110(1) and/or 110(2), or from any other suitable source.

Scheduling server 130 may also obtain one or more dynamic appointment parameters. These dynamic appointment parameters may be indicative of a travel time between location 150(1) and location 150(2). Examples of the dynamic appointment parameters include a distance between location 150(1) and location 150(2), predicted weather conditions, a preferred driving speed of the user of user device 110(1), a time of day of a potential start time of the appointment, a day of week of the potential start time of the appointment, a time of year of the potential start time of the appointment, and alternative travel options for the user of user device 110(1) (e.g., car, train, bus, walk, etc.).

Based on location 150(1), location 150(2), and the one or more dynamic appointment parameters, scheduling server 130 may calculate a predicted travel time between the location 150(1) and location 150(2). By way of example, consider a third user who needs to travel from a third location to location 150(2) for an appointment scheduled for the same time as the appointment for the users of user devices 110(1) and 110(2). The predicted travel time for the third user may be different than the predicted travel time for the user of user device 110(1) because the third user is traveling from a location that is different than location 150(1).

Based on the predicted travel time, scheduling server 130 may determine whether the user of user device 110(1) can arrive at location 150(2) before the potential start time of the appointment. For example, scheduling server 130 may identify potential start times that fit one or both of the schedules of the users of user devices 110(1) and 110(2). If it is determined that the user of user device 110(1) can arrive at location 150(2) before the potential start time of the appointment, scheduling server 130 may provide, to the user of user device 110(1), an indication of the potential start time for the appointment. Scheduling server 130 may receive a user selection of the potential start time and, in response, generate an appointment reservation for the potential start time. For example, if there is only one potential start time for the appointment, the user of user device 110(1) may confirm that potential start time. Alternatively, if there are multiple potential start times, the user of user device 110(1) may select the best (e.g., most convenient) potential start time.

If it is determined that the user of user device 110(1) cannot arrive at location 150(2) before the potential start time of the appointment (e.g., if no time slots for the appointment are available based on the predicted travel time), scheduling server 130 may perform a number of corresponding operations. In one example, scheduling server 130 may provide an alert to the user of user device 110(1). In another example, scheduling server 130 may identify an alternative location for the appointment (e.g., at a location between location 150(1) and location 150(2)). For instance, scheduling server 130 may intelligently recommend alternative meeting locations that better align with user schedules and are within reasonable travel for the users, thereby opening up a broader range of potential appointment start times. In yet another example, scheduling server 130 may providing, to the user of user device 110(1), an indication of a virtual location for a virtual appointment as an alternative to the physical appointment. For instance, scheduling server 130 may provide a link to a virtual meeting room in an online collaboration application. In still another example, scheduling server 130 may automatically reschedule (e.g., push out) or cancel the meeting. Additionally/alternatively, scheduling server 130 may provide an option for the user of user device 110(1) to manually reschedule or cancel the meeting.

In a further example, scheduling server 130 may obtain one or more subsequent dynamic appointment parameters and, based on the location 150(1), location 150(2), and the one or more subsequent dynamic appointment parameters, calculate a subsequent predicted travel time between the location 150(1) and location 150(2). Based on the subsequent predicted travel time, scheduling server 130 may subsequently determine whether the user of user device 110(1) can arrive at the location of the physical appointment before the potential start time of the appointment. Scheduling server 130 may subsequently determine that the user of user device 110(1) cannot arrive at the location of the appointment before the potential start time of the appointment (e.g., the user of user device 110(1) may be running late or caught in traffic due to an unexpected accident). If not, scheduling server 130 may provide, to the user of user device 110(1), an indication that the user of user device 110(1) cannot arrive at the location of the physical appointment before the potential start time of the physical appointment. Thus, scheduling server 130 may intelligently apply appointment availability filtering based on dynamically predicted travel times to dynamically change the availability presented to the user of user device 110(1).

It will be appreciated that scheduling server 130 may determine whether the user will arrive on time before or after the user has selected an appointment time. For example, scheduling server 130 may determine whether the user can arrive at the location of the physical appointment before the potential start time of the physical appointment, after the user has selected a previously selected start time for the physical appointment (e.g., after the appointment is initially scheduled). Alternatively, scheduling server 130 may determine whether the user can arrive at the location of the physical appointment before the potential start time of the physical appointment, before the user has selected any previously selected start time for the physical appointment (e.g., before the appointment is initially scheduled).

As such, scheduling server 130 may determine a predicted travel time between locations and, based on the predicted travel time, provide a dynamic constraint to the meeting booking process. This may ensure that appointments are scheduled at the appropriate times, thereby minimizing missed appointments and wasted productivity due to incorrectly estimated travel times. These techniques may also lower instances of network communications associated with cancelling and/or rescheduling incorrectly estimated appointments, thereby reducing the burden on network resources and improving the efficiency of network.

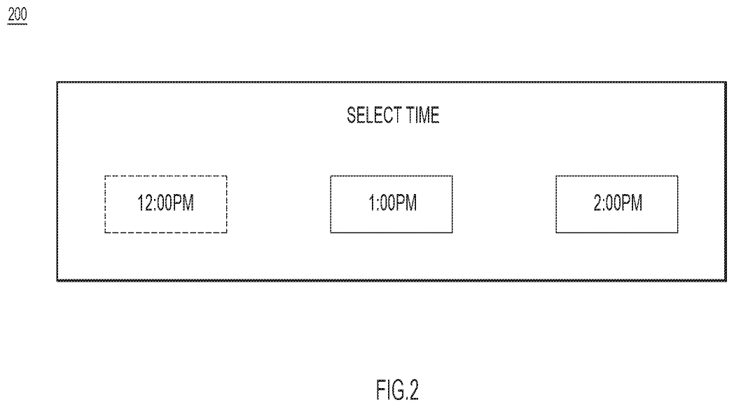

FIG. 2 illustrates an example indication 200 of a potential start time of an appointment displayed on a user device (e.g., user device 110(1). In this example, a user (e.g., the user of user device 110(1)) is available at the 12:00 pm-1:00 pm, 1:00 pm-2:00 pm, and 2:00 pm-3:00 pm time slots. However, scheduling server 130 has determined that the user has a meeting in location 150(1) that ends at 11:30 am, and that the predicted travel time from location 150(1) to location 150(2) is 45 minutes because the time slots are on a rainy Friday afternoon. As such, scheduling server 130 presents only the 1:00 pm-2:00 pm and 2:00 pm-3:00 pm time slots for selection by the user. The 12:00 pm-1:00 pm timeslot is not selectable because the user is unlikely to arrive at location 150(2) in time for the appointment at location 150(2) before the start time of 12:00 pm for that time slot. In other words, scheduling server 130 does not present the 12:00 pm-1:00 pm time slot because location 150(2) is not within an achievable travel time after the previously confirmed time slot ending at 11:30 am.

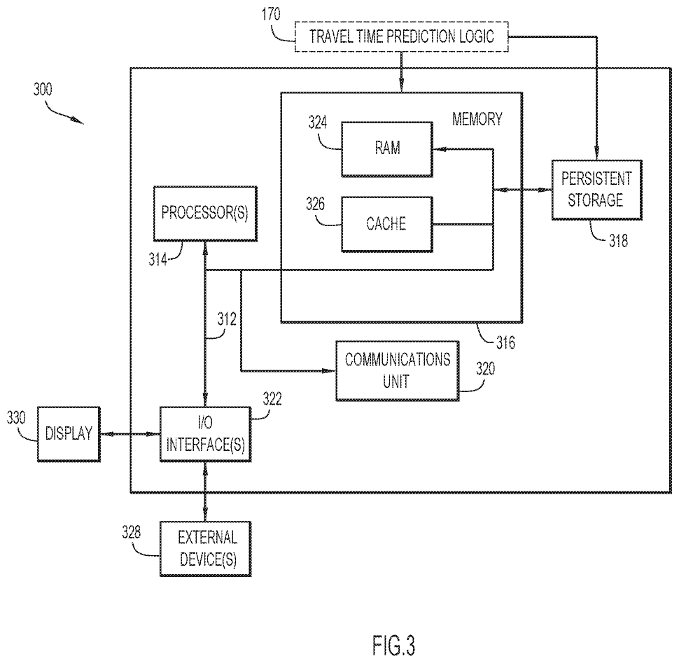

FIG. 3 illustrates a hardware block diagram of an example device 300 (e.g., a computer device, such as scheduling server 130) that may perform the functions of any of the servers or computing or control entities referred to herein in connection with scheduling an appointment based on predicted travel time. It should be appreciated that FIG. 3 provides only an illustration of one embodiment and does not imply any limitations with regard to the environments in which different embodiments may be implemented. Many modifications to the depicted environment may be made.

As depicted, the device 300 includes a bus 312, which provides communications between computer processor(s) 314, memory 316, persistent storage 318, communications unit 320, and Input/Output (I/O) interface(s) 322. Bus 312 can be implemented with any architecture designed for passing data and/or control information between processors (such as microprocessors, communications and network processors, etc.), system memory, peripheral devices, and any other hardware components within a system. For example, bus 312 can be implemented with one or more buses.

Memory 316 and persistent storage 318 are computer readable storage media. In the depicted embodiment, memory 316 includes Random Access Memory (RAM) 324 and cache memory 326. In general, memory 316 can include any suitable volatile or non-volatile computer readable storage media. Instructions for travel time prediction logic 170 may be stored in memory 316 or persistent storage 318 for execution by computer processor(s) 314.

One or more programs may be stored in persistent storage 318 for execution by one or more of the respective computer processor(s) 314 via one or more memories of memory 316. The persistent storage 318 may be a magnetic hard disk drive, a solid state hard drive, a semiconductor storage device, Read-Only Memory (ROM), Erasable Programmable ROM (EPROM), flash memory, or any other computer readable storage media that is capable of storing program instructions or digital information.

The media used by persistent storage 318 may also be removable. For example, a removable hard drive may be used for persistent storage 318. Other examples include optical and magnetic disks, thumb drives, and smart cards that are inserted into a drive for transfer onto another computer readable storage medium that is also part of persistent storage 318.

Communications unit 320, in these examples, provides for communications with other data processing systems or devices. In these examples, communications unit 320 includes one or more network interface cards. Communications unit 320 may provide communications through the use of either or both physical and wireless communications links.

I/O interface(s) 322 allows for input and output of data with other devices that may be connected to device 300. For example, I/O interface(s) 322 may provide a connection to external devices 328 such as a keyboard, keypad, a touch screen, and/or some other suitable input device. External devices 328 can also include portable computer readable storage media such as database systems, thumb drives, portable optical or magnetic disks, and memory cards.

Software and data used to practice embodiments can be stored on such portable computer readable storage media and can be loaded onto persistent storage 318 via I/O interface(s) 322. I/O interface(s) 322 may also connect to a display 330. Display 330 provides a mechanism to display data to a user and may be, for example, a computer monitor.

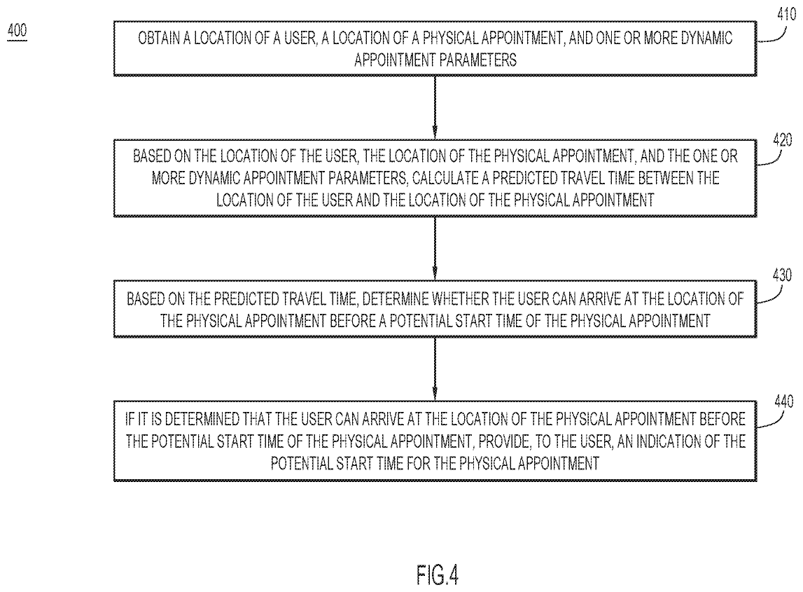

FIG. 4 is a flowchart of a method 400 for appointment scheduling based on predicted travel time. Method 400 may be performed by a server such as scheduling server 130. At 410, the server obtains a location of a user, a location of a physical appointment, and one or more dynamic appointment parameters. At 420, based on the location of the user, the location of the physical appointment, and the one or more dynamic appointment parameters, the server calculates a predicted travel time between the location of the user and the location of the physical appointment. At 430, based on the predicted travel time, the server determines whether the user can arrive at the location of the physical appointment before a potential start time of the physical appointment. At 440, if it is determined that the user can arrive at the location of the physical appointment before the potential start time of the physical appointment, the server provides, to the user, an indication of the potential start time for the physical appointment.

The programs described herein are identified based upon the application for which they are implemented in a specific embodiment. However, it should be appreciated that any particular program nomenclature herein is used merely for convenience, and thus the embodiments should not be limited to use solely in any specific application identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other repositories, queue, etc.). The data transmitted between entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., Graphical User Interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, etc.) and databases or other repositories arranged in any desired fashion, where the present embodiments may be applied to any desired type of computing environment (e.g., cloud computing, client-server, network computing, mainframe, stand-alone systems, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software (e.g., machine learning software, etc.). These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present embodiments may be available on a non-transitory computer useable medium (e.g., magnetic or optical mediums, magneto-optic mediums, floppy diskettes, Compact Disc ROM (CD-ROM), Digital Versatile Disk (DVD), memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The embodiments presented may be in various forms, such as a system, a method, and/or a computer program product at any possible technical detail level of integration. The computer program product may include a computer readable storage medium (or media) having computer readable program instructions thereon for causing a processor to carry out aspects of presented herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, EPROM, Flash memory, a Static RAM (SRAM), a portable CD-ROM, a DVD, a memory stick, a floppy disk, a mechanically encoded device, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, Instruction-Set-Architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, Field-Programmable Gate Arrays (FPGA), or Programmable Logic Arrays (PLA) may execute the computer readable program instructions by utilizing state information of the computer readable program instructions to personalize the electronic circuitry, in order to perform aspects presented herein.

Aspects of the present embodiments are described herein with reference to flowchart illustrations and/or block diagrams of methods, apparatus (systems), and computer program products according to the embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In one form, a method is provided. The method comprises: obtaining a location of a user, a location of a physical appointment, and one or more dynamic appointment parameters; based on the location of the user, the location of the physical appointment, and the one or more dynamic appointment parameters, calculating a predicted travel time between the location of the user and the location of the physical appointment; based on the predicted travel time, determining whether the user can arrive at the location of the physical appointment before a potential start time of the physical appointment; and if it is determined that the user can arrive at the location of the physical appointment before the potential start time of the physical appointment, providing, to the user, an indication of the potential start time for the physical appointment.

In one example, the method further comprises: if it is determined that the user can arrive at the location of the physical appointment before the potential start time of the physical appointment: receiving a user selection of the potential start time; and in response to receiving the user selection, generating an appointment reservation for the potential start time.

In one example, the method further comprises: obtaining one or more subsequent dynamic appointment parameters; based on the location of the user, the location of the physical appointment, and the one or more dynamic appointment parameters, calculating a subsequent predicted travel time between the location of the user and the location of the physical appointment; based on the subsequent predicted travel time, subsequently determining whether the user can arrive at the location of the physical appointment before the potential start time of the physical appointment; and if it is subsequently determined that the user cannot arrive at the location of the physical appointment before the potential start time of the physical appointment, providing, to the user, an indication that the user cannot arrive at the location of the physical appointment before the potential start time of the physical appointment.

In one example, the method further comprises: if it is determined that the user cannot arrive at the location of the physical appointment before the potential start time of the physical appointment, identifying an alternative location for the physical appointment or providing, to the user, an indication of a virtual location for a virtual appointment as an alternative to the physical appointment.

In one example, the one or more dynamic appointment parameters include a distance between the location of the user and the location of the physical appointment, predicted weather conditions, a preferred driving speed of the user, a time of day of the potential start time, a day of week of the potential start time, a time of year of the potential start time, and alternative travel options for the user.

In one example, obtaining the location of the user includes obtaining a current location of the user. In another example, obtaining the location of the user includes obtaining an anticipated location of the user.

In one example, determining whether the user can arrive at the location of the physical appointment before the potential start time of the physical appointment includes: determining whether the user can arrive at the location of the physical appointment before the potential start time of the physical appointment, before the user has selected any previously selected start time for the physical appointment. In another example, determining whether the user can arrive at the location of the physical appointment before the potential start time of the physical appointment includes: determining whether the user can arrive at the location of the physical appointment before the potential start time of the physical appointment, after the user has selected a previously selected start time for the physical appointment.

In another form, an apparatus is provided. The apparatus comprises: a network interface configured to send/or receive network communications; and one or more processors coupled to the network interface, wherein the one or more processors are configured to: obtain a location of a user, a location of a physical appointment, and one or more dynamic appointment parameters; based on the location of the user, the location of the physical appointment, and the one or more dynamic appointment parameters, calculate a predicted travel time between the location of the user and the location of the physical appointment; based on the predicted travel time, determine whether the user can arrive at the location of the physical appointment before a potential start time of the physical appointment; and if it is determined that the user can arrive at the location of the physical appointment before the potential start time of the physical appointment, provide, to the user, an indication of the potential start time for the physical appointment.

In another form, one or more non-transitory computer readable storage media are provided. The non-transitory computer readable storage media are encoded with instructions that, when executed by a processor, cause the processor to: obtain a location of a user, a location of a physical appointment, and one or more dynamic appointment parameters; based on the location of the user, the location of the physical appointment, and the one or more dynamic appointment parameters, calculate a predicted travel time between the location of the user and the location of the physical appointment; based on the predicted travel time, determine whether the user can arrive at the location of the physical appointment before a potential start time of the physical appointment; and if it is determined that the user can arrive at the location of the physical appointment before the potential start time of the physical appointment, provide, to the user, an indication of the potential start time for the physical appointment.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
obtaining a location of a user, a location of a physical appointment, and one or more dynamic appointment parameters;
based on the location of the user, the location of the physical appointment, and the one or more dynamic appointment parameters, calculating a predicted travel time between the location of the user and the location of the physical appointment;
based on the predicted travel time, determining whether the user can arrive at the location of the physical appointment before a potential start time of the physical appointment; and
if it is determined that the user can arrive at the location of the physical appointment before the potential start time of the physical appointment, providing, to the user, an indication of the potential start time for the physical appointment.

2. The method of claim 1, further comprising:
if it is determined that the user can arrive at the location of the physical appointment before the potential start time of the physical appointment:
receiving a user selection of the potential start time; and
in response to receiving the user selection, generating an appointment reservation for the potential start time.

3. The method of claim 1, further comprising:
obtaining one or more subsequent dynamic appointment parameters;
based on the location of the user, the location of the physical appointment, and the one or more dynamic appointment parameters, calculating a subsequent predicted travel time between the location of the user and the location of the physical appointment;
based on the subsequent predicted travel time, subsequently determining whether the user can arrive at the location of the physical appointment before the potential start time of the physical appointment; and
if it is subsequently determined that the user cannot arrive at the location of the physical appointment before the potential start time of the physical appointment, providing, to the user, an indication that the user cannot arrive at the location of the physical appointment before the potential start time of the physical appointment.

4. The method of claim 1, further comprising:
if it is determined that the user cannot arrive at the location of the physical appointment before the potential start time of the physical appointment, identifying an alternative location for the physical appointment.

5. The method of claim 1, further comprising:
if it is determined that the user cannot arrive at the location of the physical appointment before the potential start time of the physical appointment, providing, to the user, an indication of a virtual location for a virtual appointment as an alternative to the physical appointment.

6. The method of claim 1, wherein the one or more dynamic appointment parameters include a distance between the location of the user and the location of the physical appointment, predicted weather conditions, a preferred driving speed of the user, a time of day of the potential start time, a day of week of the potential start time, a time of year of the potential start time, and alternative travel options for the user.

7. The method of claim 1, wherein obtaining the location of the user includes obtaining a current location of the user.

8. The method of claim 1, wherein obtaining the location of the user includes obtaining an anticipated location of the user.

9. The method of claim 1, wherein determining whether the user can arrive at the location of the physical appointment before the potential start time of the physical appointment includes:
determining whether the user can arrive at the location of the physical appointment before the potential start time of the physical appointment, before the user has selected any previously selected start time for the physical appointment.

10. The method of claim 1, wherein determining whether the user can arrive at the location of the physical appointment before the potential start time of the physical appointment includes:
determining whether the user can arrive at the location of the physical appointment before the potential start time of the physical appointment, after the user has selected a previously selected start time for the physical appointment.

11. An apparatus comprising:
a network interface configured to send/or receive network communications; and
one or more processors coupled to the network interface, wherein the one or more processors are configured to:
obtain a location of a user, a location of a physical appointment, and one or more dynamic appointment parameters;
based on the location of the user, the location of the physical appointment, and the one or more dynamic appointment parameters, calculate a predicted travel time between the location of the user and the location of the physical appointment;
based on the predicted travel time, determine whether the user can arrive at the location of the physical appointment before a potential start time of the physical appointment; and
if it is determined that the user can arrive at the location of the physical appointment before the potential start time of the physical appointment, provide, to the user, an indication of the potential start time for the physical appointment.

12. The apparatus of claim 11, wherein the one or more processors are further configured to:
if it is determined that the user can arrive at the location of the physical appointment before the potential start time of the physical appointment:
receive a user selection of the potential start time; and
in response to receiving the user selection, generate an appointment reservation for the potential start time.

13. The apparatus of claim 11, wherein the one or more processors are further configured to:
obtain one or more subsequent dynamic appointment parameters;
based on the location of the user, the location of the physical appointment, and the one or more dynamic appointment parameters, calculate a subsequent predicted travel time between the location of the user and the location of the physical appointment;
based on the subsequent predicted travel time, subsequently determine whether the user can arrive at the location of the physical appointment before the potential start time of the physical appointment; and
if it is subsequently determined that the user cannot arrive at the location of the physical appointment before the potential start time of the physical appointment, provide, to the user, an indication that the user cannot arrive at the location of the physical appointment before the potential start time of the physical appointment.

14. The apparatus of claim 11, wherein the one or more processors are further configured to:
if it is determined that the user cannot arrive at the location of the physical appointment before the potential start time of the physical appointment, identify an alternative location for the physical appointment.

15. The apparatus of claim 11, wherein the one or more processors are further configured to:
if it is determined that the user cannot arrive at the location of the physical appointment before the potential start time of the physical appointment, provide, to the user, an indication of a virtual location for a virtual appointment as an alternative to the physical appointment.

16. The apparatus of claim 11, wherein the one or more dynamic appointment parameters include a distance between the location of the user and the location of the physical appointment, predicted weather conditions, a preferred driving speed of the user, a time of day of the potential start time, a day of week of the potential start time, a time of year of the potential start time, and alternative travel options for the user.

17. One or more non-transitory computer readable storage media encoded with instructions that, when executed by a processor, cause the processor to:
obtain a location of a user, a location of a physical appointment, and one or more dynamic appointment parameters;
based on the location of the user, the location of the physical appointment, and the one or more dynamic appointment parameters, calculate a predicted travel time between the location of the user and the location of the physical appointment;
based on the predicted travel time, determine whether the user can arrive at the location of the physical appointment before a potential start time of the physical appointment; and
if it is determined that the user can arrive at the location of the physical appointment before the potential start time of the physical appointment, provide, to the user, an indication of the potential start time for the physical appointment.

18. The one or more non-transitory computer readable storage media of claim 17, wherein the instructions further cause the processor to:
if it is determined that the user can arrive at the location of the physical appointment before the potential start time of the physical appointment:
receive a user selection of the potential start time; and
in response to receiving the user selection, generate an appointment reservation for the potential start time.

19. The one or more non-transitory computer readable storage media of claim 17, wherein the instructions further cause the processor to:
obtain one or more subsequent dynamic appointment parameters;
based on the location of the user, the location of the physical appointment, and the one or more dynamic appointment parameters, calculate a subsequent predicted travel time between the location of the user and the location of the physical appointment;
based on the subsequent predicted travel time, subsequently determine whether the user can arrive at the location of the physical appointment before the potential start time of the physical appointment; and
if it is subsequently determined that the user cannot arrive at the location of the physical appointment before the potential start time of the physical appointment, provide, to the user, an indication that the user cannot arrive at the location of the physical appointment before the potential start time of the physical appointment.

20. The one or more non-transitory computer readable storage media of claim 17, wherein the instructions further cause the processor to:
if it is determined that the user cannot arrive at the location of the physical appointment before the potential start time of the physical appointment, identify an alternative location for the physical appointment.
